(19) United States
(12) Patent Application Publication
(10) Pub. No.: US 2008/0191874 A1
(43) Pub. Date: Aug. 14, 2008

(54) Method and system for inspection of load-carrying vehicles

(76) Inventors: Randy M. Walker, Knoxville, TN (US); Robert K. Abercrombie, Knoxville, TN (US); Stephen G. Batsell, Oak Ridge, TN (US)

Correspondence Address: QUARLES & BRADY, 411 EAST WISCONSIN AVENUE, MILWAUKEE, WI, 53202-4497, US

(21) Appl. No.: 11/703,992

(22) Filed: Feb. 8, 2007

(51) Int. Cl. G08B 13/14; G06K 9/18; G08B 21/00

(52) U.S. Cl. 340/572.1; 340/540; 382/182

(57) ABSTRACT

The invention provides a method and system for identifying vehicles by commercial or government carrier, equipment, driver and cargo at a single inspection station using a plurality of sensors connected to a computer system that is networked to access records of various state and federal agencies based on the data sensed on the vehicle using the sensors in the inspection station.

### STATEMENT REGARDING FEDERALLY SPONSORED RESEARCH

This invention was made with Government support under Contract No. DE-AC05-00OR22725 awarded to UT-Battelle, LLC, by the U.S. Department of Energy. The Government has certain rights in this invention.

### TECHNICAL FIELD

The current invention relates to a method and system for inspection of vehicles, such as trucks, including identifying the vehicles, identifying their drivers and identifying characteristics of loads carried by such vehicles.

### BACKGROUND OF THE INVENTION

Truck inspection and weighing stations are well known and have been used by states to regulate commercial truck traffic for many years. The ratification of the North American Free Trade Agreement has opened U.S. borders to truck traffic from Canada and Mexico. Due to an increased need to regulate truck traffic including inspection of loads and identification of drivers, there is a need for a system more comprehensive than heretofore known. Such a system should take advantage of various computer and sensor and identification technologies being developed for a broad range of uses.

Such systems have application in enforcing laws and regulations, including commerce regulations, hazardous materials regulations, highway safety regulations. civil and criminal laws, environmental regulations and homeland security regulations. Such systems have use for both government and civilian fleets of vehicles. Such systems could be applied to load-carrying vehicles other than trucks, such as buses, SUV's and even automobiles.

Current truck inspection stations have utilized mainly scales and visual inspections.

### SUMMARY OF THE INVENTION

The invention provides a method and system for identifying vehicles by commercial or government carrier, equipment, driver and cargo at an inspection station.

A sensor is provided to sense a vehicle ID number and through the computer system a record is accessed to identify parameters of the vehicle. For commercial vehicles and private vehicles, this data would be received from a state Department of Transportation. One or more additional sensors are provided to identify the driver, and if a driver's license is number is obtained, a record is accessed with data from a state Department of Transportation to identify parameters of the driver. One or more sensors are also provided to sense the cargo or contents of the vehicle, such as hazardous or radioactive materials. The personnel at the inspection station examine the records for any inconsistency that might identify illegal or unauthorized activities concerning the driver, the vehicle or the load.

For commercial vehicles, an additional sensor is provided to sense a commercial carrier ID No. from the vehicle and through a computer system a record is accessed with data from the US Department of Transportation. This data is helpful in determining if the vehicle is authorized to carry any type of hazardous material.

The invention can also be applied to government vehicles which have a bumper number in lieu of a vehicle registration number. In this environment, the inspection station may include a plurality of sub-stations.

Other objects and advantages of the invention, besides those discussed above, will be apparent to those of ordinary skill in the art from the description of the preferred embodiments which follows. In the description, reference is made to the accompanying drawings, which form a part hereof, and which illustrate examples of the invention. Such examples, however, are not exhaustive of the various embodiments of the invention, and therefore reference is made to the claims which follow the description for determining the scope of the invention.

### BRIEF DESCRIPTION OF THE DRAWINGS

FIG. 1 is a perspective view of a vehicle in an inspection station of the present invention;

FIG. 2 is a close up perspective view a vehicle in an inspection station of the present invention;

FIG. 3 is a block diagram of the system of the present invention installed in the inspection station of FIGS. 1 and 2;

FIG. 4 is a diagram of a commercial carrier record stored in a computer system and available to the inspection station of the present invention;

FIG. 5 is a diagram of a vehicle record stored in a computer system and available to the inspection station of the present invention;

FIG. 6 is a diagram of a driver's license record stored in a computer system and available to the inspection station of the present invention; and

FIG. 7 is a block diagram of a second embodiment of an inspection station according to the present invention.

### DETAILED DESCRIPTION OF THE PREFERRED EMBODIMENTS

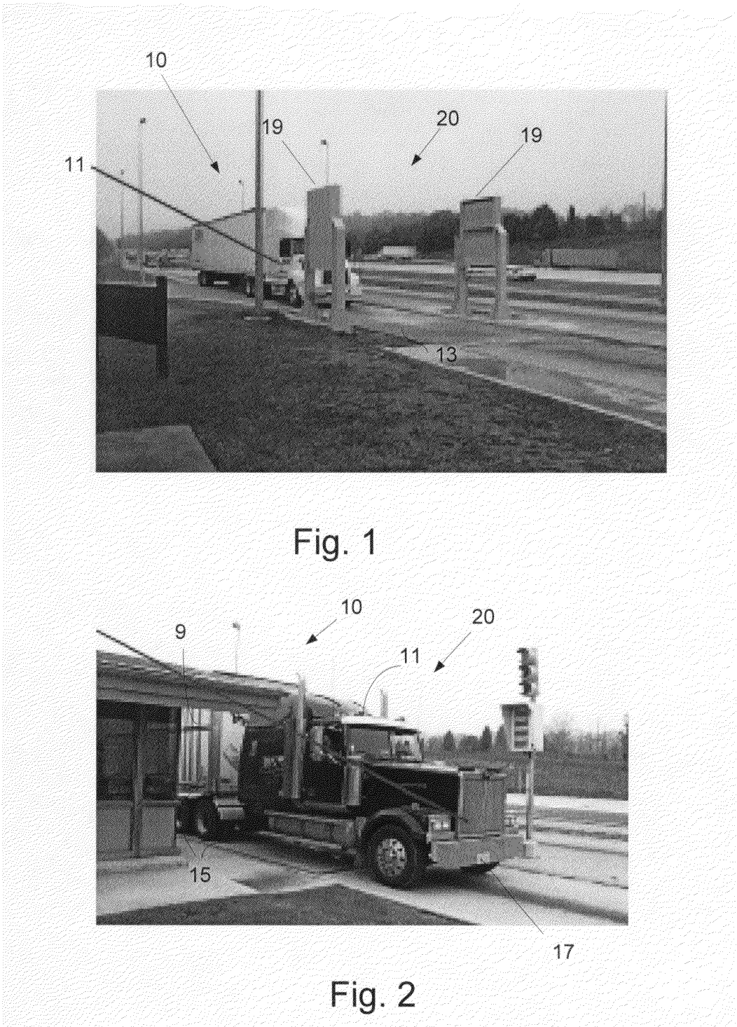

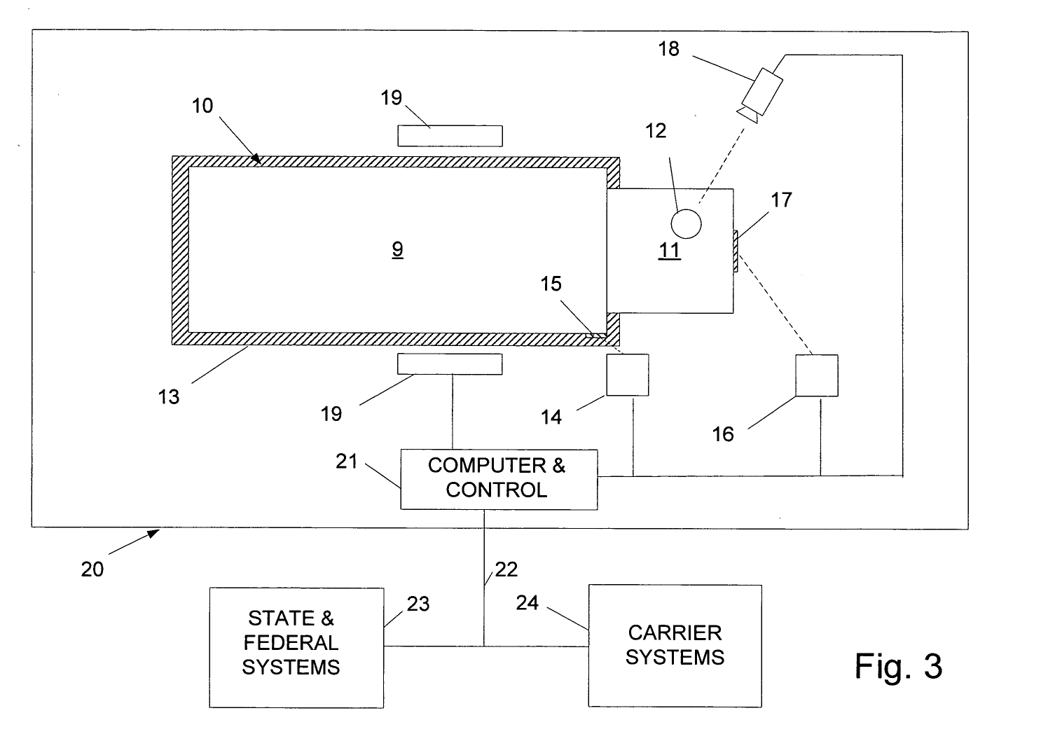

FIGS. 1 and 2 show a wheeled vehicle 10 including a power unit 11 and a trailer 9 as it pulls into an inspection station 20. FIG. 1 shows a weighing pad 13 and some load sensors 19 on the right and left sides of the weighing pad 13. The vehicle 10 is driven onto the weighing pad 13, and while being weighed is also sensed by sensors 19 to see if the load in the trailer 9 contains radioactive or hazardous materials. These sensors 19 are also shown in FIG. 3 where they interface to a computer system 21 and provide reports of material characteristics of the load, such as probable type of material if radioactive, and identification of any hazardous type of material.

FIG. 2 illustrates that the vehicle 10 has certain identifying indicia such as vehicle license tag 17 and an RFID carrier tag 15 on one side of the power unit 11 and trailer 9. As seen in FIG. 3, a sensor 14 such as an RFID reader can read the carrier tag 15 and provide the number as an input to a computer and control system 21 in the inspection station 20. As is known in the art, RFID readers read information commonly contained in a bar code or other pattern using short range radio signals. An OCR (optical character recognition) system 16 can read the vehicle registration number from the license tag 17. The RFID reader and OCR device are typically mounted to a stationary support, but they could also be handheld. A photo or video camera 18 can be used to capture an image of the driver 12.

The computer system 21 at the inspection station is connected via a computer network 22 to state and federal computer systems 23 of the respective state and federal departments of transportation, including departments of motor vehicle and driver licensing. The computer system 21 at the inspection station is also connected via a network 22 to computer systems 24 of the respective commercial carriers.

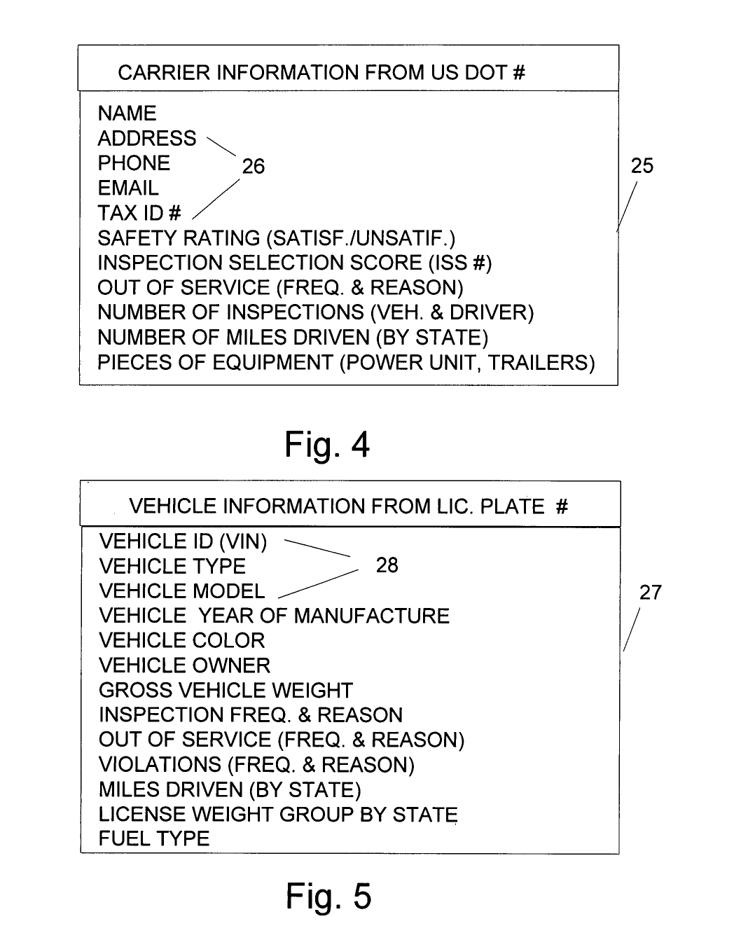

The sensor 14 is provided to sense a commercial carrier ID No. from the vehicle and through the computer systems 23 a record 25 (FIG. 4) is accessed with data from the US Department of Transportation. This database record 25 includes fields 26 with data for such information as carrier name, address, phone, email, tax id no., safety rating (e.g., satisfactory/conditional/unsatisfactory), inspection selection score, out of service frequency and reason, number of inspections, number of miles driven by state and number of pieces of equipment.

Similarly, the sensor 16 (FIG. 3) is provided to sense the vehicle registration number and through the computer system a record 27 (FIG. 5) is accessed with data from a state Department of Transportation to identify parameters of the vehicle. This database record 27 includes fields 28 with data such as vehicle identification number (VIN), vehicle type, vehicle model, vehicle year of manufacture, vehicle color, vehicle owner, gross vehicle weight, inspection frequency and reason, out of service frequency and reason, violation frequency and reason, miles driven by state, license weight group by state and fuel type. Whenever the term ID number or identification number is used herein, it should be understood that such an identifier may include alphanumeric or other characters besides numbers from “0” to “9”.

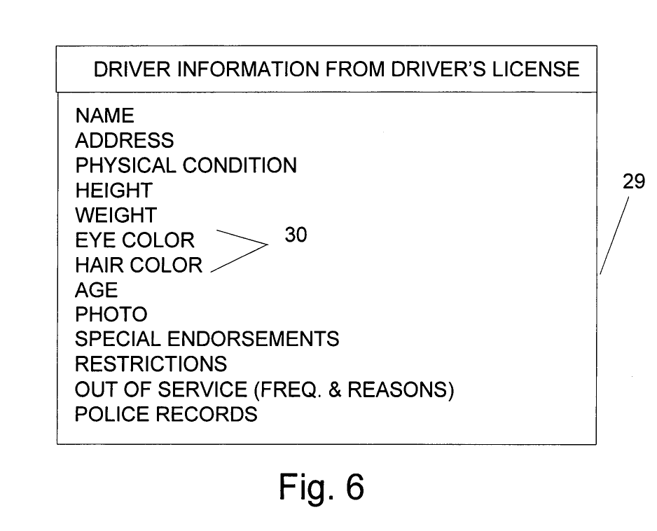

One or more additional sensors 8, are provided to identify the driver 12, and if a driver's license is number is obtained, it is input into the computer system 21 and a record 29 (FIG. 6) is accessed with data from a state Department of Transportation. This record 28 includes fields 30 to identify parameters of the driver, such as name, address, physical condition, height, weight, eye color, hair color, age, photo, special endorsements, restrictions, out of service frequency and reasons and police records. If the driver is not licensed in the US, then the data may have to be obtained from a federal system interfacing to international systems.

And, one or more sensors 19 are provided to sense the cargo or contents of the vehicle, such as hazardous or radioactive materials. The personnel at the inspection station 20 examine the records 25, 27 and 29 for any inconsistency with detected information that might identify illegal or unauthorized activities concerning the driver, the vehicle or the load.

Besides the sensors and parameters discussed above, additional sensors can be used to check various vehicle conditions. For example, brakes can be inspected using infrared sensors for sensing heat or using a strain gauge to check brake integrity. Tires can be inspected using infrared sensors for checking heat and imaging sensor can be used to measure tire pressure, tread depth and sidewall integrity. Carrier identification can be performed by reading a smart card or through a satellite detection of a geographical location of a vehicle as it is tracked along its route. Driver's can be identified by sensing smart cards as well as a driver's license or through biometrics such as retinal eye scans or fingerprint sensing as just two examples. Besides the agencies mentioned above, the databases may be accessed at various law enforcement agencies.

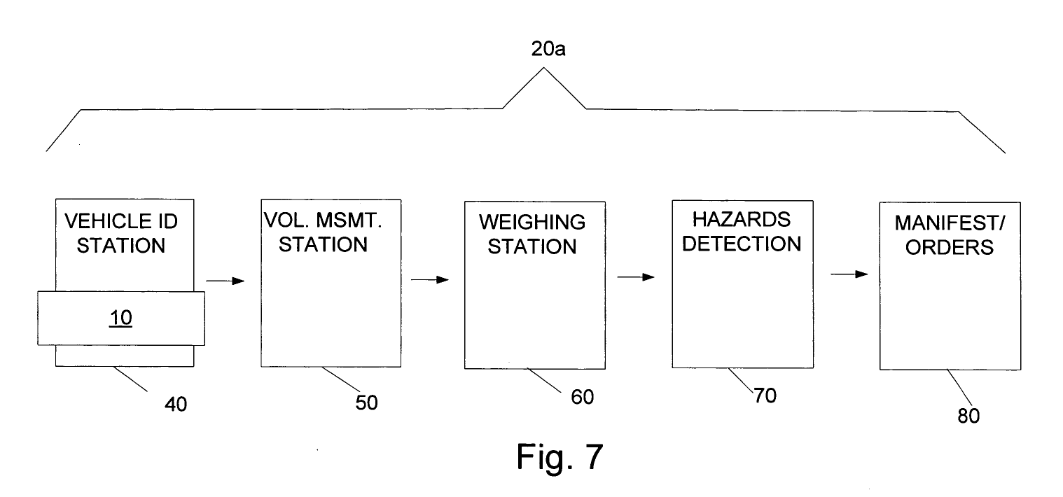

FIG. 7 shows a second embodiment of an inspection station 20a with sub-stations 40, 50, 60, 70 and 80 that would be used for government vehicles. In this inspection system, an initial station 40 with a sensor would be used to ID the vehicle by bumper number (no state license tag) and this provides the vehicle information 27 similar to that shown in FIG. 5. A second sub-station 50 is used to determine volume of the vehicle and a third sub-station 60 is used to weigh the vehicle. A fourth sub-station 70 with suitable sensors like sensor 19 in FIGS. 1 and 3 is used to check for hazardous materials. A fifth sub-station 80 is used to check the manifest or government orders for movement of the vehicle and this is an equivalent of checking the carrier information 25 and driver license information 29 in the previous embodiments.

This has been a description of the preferred embodiments of the invention. The present invention is intended to encompass additional embodiments including modifications to the details described above which would nevertheless come within the scope of the following claims.

What is claimed is:

1. A method for inspecting a vehicle at a vehicle inspection station, the method comprising:
sensing a vehicle ID number and accessing a record with data related to the vehicle ID number;
sensing an identity of a driver and accessing a record with data related to the driver;
checking data from the records being accessed to verify that the driver is authorized to operate the vehicle that is identified; and
sensing a characteristic of materials present in load being carried by the vehicle to verify that the materials are authorized to be carried by the vehicle.

2. The method of claim 1, wherein the vehicle ID number is a vehicle license tag number.

3. The method of claim 2, wherein the sensing of the vehicle ID number is carried out by optical character recognition of the vehicle ID number.

4. The method of claim 1, further comprising sensing a carrier ID number and accessing a record with data cross-referenced to the carrier operating the vehicle.

5. The method of claim 4, wherein the carrier ID number is sensed with a reader for close proximity reading of a bar code or other pattern on the vehicle.

6. The method of claim 1, wherein the vehicle ID number is a bumper number on a government vehicle.

7. The method of claim 1, wherein the identity of the driver is sensed by inputting a number associated with that driver to access a driver record.

8. The method of claim 1, wherein the identity of the driver is sensed by a camera.

9. The method of claim 1, wherein the records that are accessed are obtained through networks communicating with databases at agencies of state governments.

10. The method of claim 1, wherein the records that are accessed are obtained through networks communicating with a database at an agency of the federal government.

11. An inspection system for inspecting a vehicle at a vehicle inspection station, the system comprising:
a computer for reading in data from a plurality of sensors, including
a first sensor for sensing a vehicle ID number;
a input device for inputting identity information concerning of a driver of the vehicle into the computer;
a second sensor for sensing a characteristic of materials present in load being carried by the vehicle; and
wherein the computer is responsive to data from the first and second sensors and the input device to access database records available from government agencies to verify that the driver is properly identified and is authorized to drive the vehicle and that the vehicle is properly identified.

12. The inspection system of claim 11, further comprising a third sensor for sensing a carrier ID number and wherein the computer is responsive to data from the third sensor for accessing a record with data cross-referenced to the carrier operating the vehicle.

13. The inspection system of claim 12, wherein the third sensor is an RFID sensor for reading a tag on a vehicle.

14. The inspection system of claim 11, wherein the computer is responsive to data from the third sensor to verify that the vehicle is authorized to transport a type of load being sensed by the inspection system.

15. The inspection system of claim 12, wherein the first sensor is an optical character reader.

16. The inspection system of claim 11, wherein the input device is a camera.

17. The inspection system of claim 11, wherein the input device is used to entered a driver's license number into the computer.

18. The inspection system of claim 11, wherein the computer is connected via a network to a database maintained by a state governmental agency.
